(19) United States
(12) Patent Application Publication
(10) Pub. No.: US 2015/0348121 A1
(43) Pub. Date: Dec. 3, 2015

(54) EVENT SEATING FOR TICKET BUYERS

(71) Applicant: MasterCard International Incorporated, Purchase, NY (US)

(72) Inventors: Edward Lee, Scarsdale, NY (US); Marianne Iannace, North Salem, NY (US)

(73) Assignee: MasterCard International Incorporated, Purchase, NY (US)

(21) Appl. No.: 14/291,264

(22) Filed: May 30, 2014

(51) Int. Cl. G06Q 30/02; G06Q 10/02

(52) U.S. Cl. CPC G06Q 30/0269; G06Q 10/02

(57) ABSTRACT

A method includes receiving, from a user, a request for seating at an event. The method further includes fulfilling the request for seating, based at least in part on spending habit information for the user, where the spending habit information is derived from data indicative of payment card account transactions by the user.

### BACKGROUND

It is common to sell tickets automatically online (i.e., via websites) for events such as musical performances, theatrical performances and sporting events. In some cases, the user/ticket-buyer may be presented with a display which by color coding indicates what seats remain available for the event that the user is interested in. In other cases, the user may be prompted to select a section of the venue (e.g., orchestra front, orchestra rear, mezzanine, balcony, etc.) and upon selection of a section by the user, the website computer may automatically assign seats according to an algorithm that automatically selects the “best seats available,” where the “best” is determined according to considerations such as nearness to the front and center of the stage or according to a geometric relationship between the available seating and certain portions of the playing surface (in the case of a sporting event).

The present inventors have now recognized that there are opportunities to improve automatic event seating processes so as to match the seats offered to particular interests or characteristics of the users.

### BRIEF DESCRIPTION OF THE DRAWINGS

Features and advantages of some embodiments of the present disclosure, and the manner in which the same are accomplished, will become more readily apparent upon consideration of the following detailed description of the disclosure taken in conjunction with the accompanying drawings, which illustrate preferred and exemplary embodiments and which are not necessarily drawn to scale, wherein:

FIG. 1 is a block diagram that illustrates a conventional payment system that may be a source of information utilized according to some aspects of this disclosure.

FIG. 2 is a block diagram representation of an automated event seating system provided according to aspects of this disclosure.

FIG. 3 is a block diagram representation of a computer system provided according to aspects of the present disclosure.

FIG. 4 is a flow chart that illustrates aspects of the present disclosure, including a portion of the operations of the computer system of FIG. 3.

FIG. 5 is a block diagram representation of another computer system provided according to aspects of the present disclosure.

FIGS. 6A and 6B together form a flow chart that illustrates aspects of the present disclosure, including a portion of the operations of the computer system of FIG. 5.

### DETAILED DESCRIPTION

In general, and for the purpose of introducing concepts of embodiments of the present disclosure, characteristics and interests, etc. of users of automated ticketing systems may be inferred by analysis of data generated from payment card system transactions performed by the users. Profiles derived from the transaction data analysis may be taken into account by an event seating website in recommending seats to users. With this approach, the seats recommended by the website may be particularly suitable to the users.

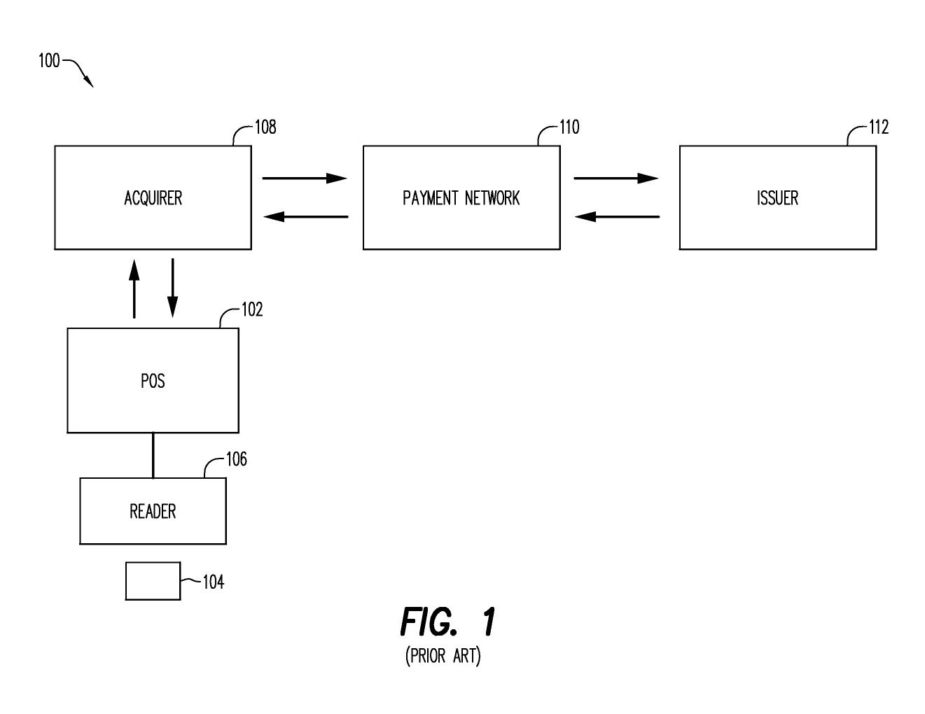

FIG. 1 is a block diagram that illustrates a conventional payment system 100 that may be a source of information utilized according to some aspects of this disclosure. In particular, the representation of the payment system 100 in FIG. 1 reflects the flow of information and messaging for a single payment card transaction.

Thus, the transaction in question may originate at a POS (point of sale) device 102 located in a merchant store (which is not separately indicated). A payment card 104 is shown being presented to a reader component 106 associated with the POS device 102. The payment card 104 is often implemented as a physical magnetic stripe card, although alternatively, or in addition, the payment card 104 may include capability for being read by proximity RF (radio frequency) communication with an integrated circuit (IC) chip (not separately shown). Alternatively, the payment card 104 may encompass a virtual card account number or an electronic wallet, as is known in the art. The primary account number (PAN) for the payment card account represented by the payment card 104 may be stored on the magnetic stripe (not separately shown) and/or the IC chip (if present) for reading by the reader component 106 of the POS device 102.

In some installations, the reader component 106 may be configured to perform either or both of magnetic stripe reading and reading of IC chips by proximity RF communications. Thus, the payment card 104 may be swiped through a mag stripe reading portion (not separately shown) of the reader component 106, or may be tapped on a suitable surface of the reader component 106 to allow for proximity reading of its IC chip.

In some transactions, instead of a card-shaped payment device, such as the payment card 104, a suitable conventional payment-enabled mobile phone or a payment fob may be presented to and read by the reader component 106.

A computer 108 operated by an acquirer (acquiring financial institution) is also shown as part of the payment system 100 in FIG. 1. The acquirer computer 108 may operate to receive an authorization request for the transaction from the POS device 102. The acquirer computer 108 may route the authorization request via a payment network 110 to the server computer 112 operated by the issuer of the payment card account that is available for access by the payment card 104. The authorization response generated by the payment card issuer server computer 112 may be routed back to the POS device 102 via the payment network 110 and the acquirer computer 108.

The payment network 110 may be, for example, the well-known Banknet system operated by MasterCard International Incorporated, which is the assignee hereof.

The diagram shown in FIG. 1 schematically represents an in-store payment card purchase transaction. However, as is well known, payment card accounts may also be used for online (e-commerce) purchase transactions. In such a transaction, the merchant's e-commerce server computer (not shown) may take the place of the indicated POS device and may be in communication with the acquirer.

The components of the system 100 as depicted in FIG. 1 are only those that are needed for processing a single transaction. A typical payment system 100 now in use may include a considerable number of payment card issuers and their computers, a considerable number of acquirers and their computers, and numerous merchants and their POS devices and associated reader components. The system may also include a very large number of payment card account holders, who carry payment cards and/or other payment-enabled devices.

In the course of receiving and relaying the authorization requests and responses, the payment network 110 may receive and store large quantities of transaction data, including, for each one of many transactions, the PAN (primary account number), the date and time of the transaction, the transaction total amount, the merchant, and the store location. In some cases, the transaction data may also be indicative of the type of goods or services purchased. This transaction data, referred to above and below as payment network transaction data, may serve as the raw material for deriving user profiles for the payment card account holders. These user profiles may be used, according to aspects of this disclosure, to enhance operation of automated event seating websites.

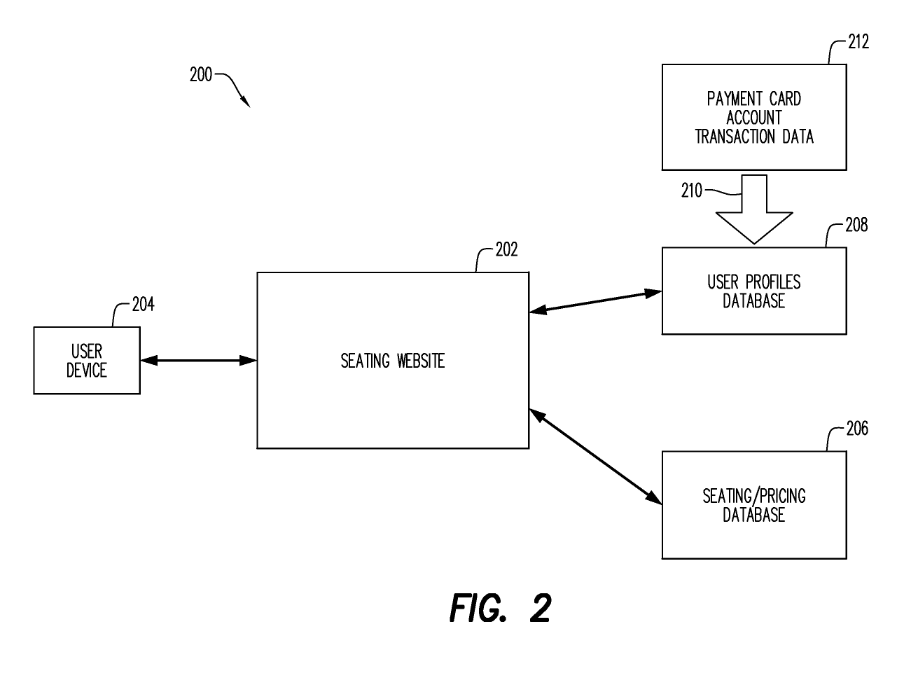

FIG. 2 is a block diagram representation of an automated event seating system 200 provided according to aspects of this disclosure. In FIG. 2, the automated event seating system 200 is depicted largely in functional terms; details of hardware constituting aspects of the automated event seating system 200 will be described below in conjunction with subsequent drawings.

One important element of the automated event seating system 200 is an automated seating website 202. In many respects, the automated seating website 202 may be conventional. However, in other respects the automated seating website 202 may operate in accordance with teachings of the present disclosure so as to provide improved functionality.

FIG. 2 also shows a user device 204 in communication with the automated seating website 202. The user device 204 may be, for example, a conventional personal computer running a conventional browser program, or a conventional tablet computer or smartphone. As is customary, an individual user (not shown) may operate the user device 204 so as to access the automated seating website 202 (via the internet) for the purpose of reserving seats and purchasing tickets for an event. As used herein, the term “event” should be understood to include sporting events, theatrical performances, musical performances, dance performances, operas, rock concerts, concerts featuring famous entertainers, music or film festivals (of the kind that provide for reserved seating), etc. It will be noted that some of the categories of events listed above are partially overlapping; for example, an opera may be considered both a musical performance and a theatrical performance. The term “event venue” will be understood to include facilities at which events take place, and may include sports stadiums, theaters, arenas, concert halls, etc. It will be assumed that the event venues include seats that are uniquely identified, such as with numbering by row, section, level, etc., of the facility.

Although only one user device 204 is shown in the drawing, it will be understood that the automated seating website 202 may be operative to handle requests/transactions initiated from numerous user devices, simultaneously and/or sequentially.

In its operations, the automated seating website 202 may access and update a seating/pricing database 206. In many respects, the seating/pricing database 206 may be conventional, in that it may store data indicative of seat pricing and seat availability for one or more events. However, in other respects, the seating/pricing database 206 may provide additional information that is useful in implementing aspects of the present disclosure. For example, for seats that have been reserved, in some embodiments the seating/pricing database 206 may store information indicative of the identity of the individual user who reserved the seats. (As used herein, the term “reserving a seat” will be understood to include purchasing a ticket for a particular seat in an event venue.) In addition or alternatively, the seating/pricing database 206 may associate at least some data from user profiles with the seats reserved by corresponding users.

In accordance with teachings of the present disclosure, the automated seating website 202 also accesses a user profiles database 208. The user profiles database 208 may store profiles concerning users or prospective users of the automated seating website 202. As indicated at 210, the information in the user profiles database 208 may, in accordance with aspects of the present disclosure, have been derived from payment card account transaction data 212. As will be understood from subsequent discussion, the automated seating website 202 may utilize profiles of individual users, available from user profiles database 208, in selecting seating for events in accordance with interests and/or characteristics of the users who are requesting seating via the automated seating website 202. Details of the user profiles contained in the user profiles database 208, and of their derivation from payment card account transaction data, will be described below.

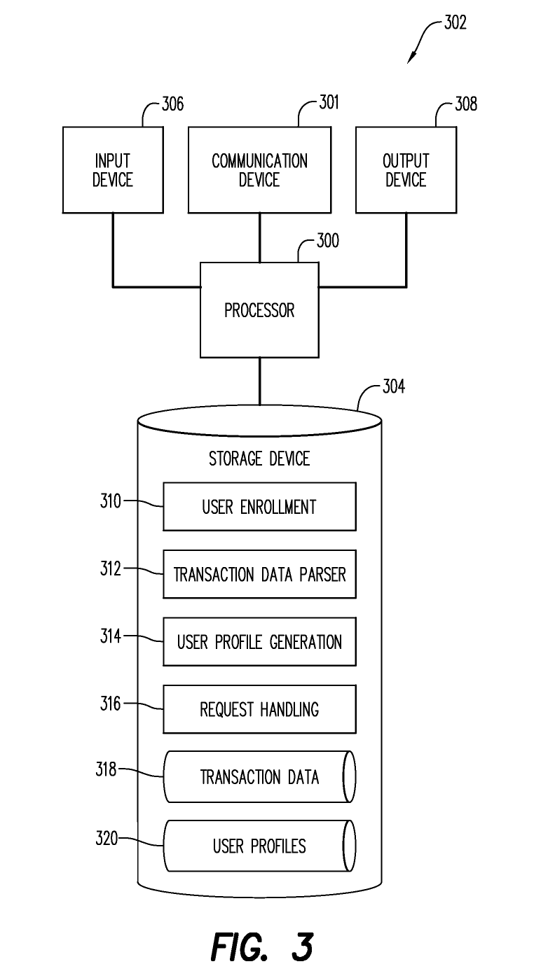

At least some of the functionality represented by blocks 208 and 212 in FIG. 2 may be implemented in a computer system operated, e.g., by an operator of a payment network such as the payment network 110 shown in FIG. 1. As noted above, one operator of such a payment network is MasterCard International Incorporated, the assignee of this disclosure. A computer system that implements blocks 208 and 212 may hereinafter be referred to as a “user profile server computer.” FIG. 3 is a block diagram illustration of such a computer, which is generally indicated in the drawing by reference numeral 302.

Referring then to FIG. 3, the user profile server computer 302 may be conventional in its hardware aspects, but may be controlled by software to cause it to function as described herein. For example, the user profile server computer 302 may be constituted by conventional server computer hardware.

The user profile server computer 302 may include a computer processor 300 operatively coupled to a communication device 301, a storage device 304, an input device 306 and an output device 308.

The computer processor 300 may be constituted by one or more conventional processors. Processor 300 operates to execute processor-executable steps, contained in program instructions described below, so as to control the user profile server computer 302 to provide desired functionality.

Communication device 301 may be used to facilitate communication with, for example, other devices (such as one or more computers that host event seating websites; and/or one or more devices operated by individual users, as discussed below). For example, communication device 301 may comprise numerous communication ports (not separately shown), to allow the user profile server computer 302 to communicate simultaneously with a number of other computers and other devices.

Input device 306 may comprise one or more of any type of peripheral device typically used to input data into a computer. For example, the input device 306 may include a keyboard and a mouse. Output device 308 may comprise, for example, a display and/or a printer.

Storage device 304 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 304 stores one or more programs for controlling processor 300. The programs comprise program instructions (which may be referred to as computer readable program code means) that contain processor-executable process steps of the user profile server computer 302, executed by the processor 300 to cause the user profile server computer 302 to function as described herein.

The programs may include one or more conventional operating systems (not shown) that control the processor 300 so as to manage and coordinate activities and sharing of resources in the user profile server computer 302, and to serve as a host for application programs (described below) that run on the user profile server computer 302.

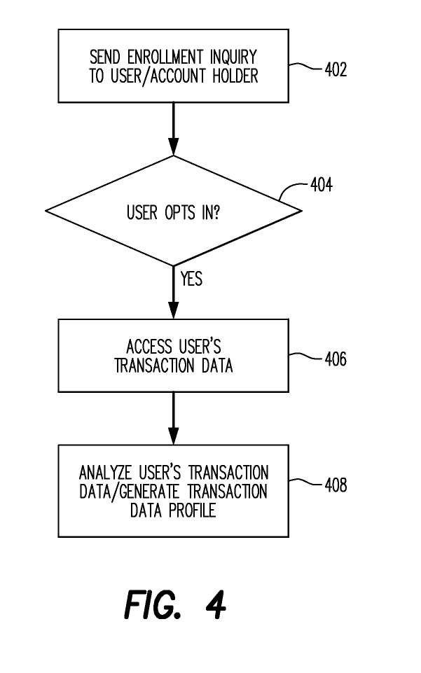

The programs stored in the storage device 304 may also include a user enrollment application program 310 that controls the processor 300 to enable the user profile server computer 302 to communicate with potential users/ticket-buyers who are also holders of payment card accounts in the payment system 100 of FIG. 1. (The terms “user” and “account holder” or “payment card account holder” may at times be used interchangeably herein.) Details of the functionality provided by the user enrollment application program 310 will be discussed below in conjunction with FIG. 4. In brief overview, the user enrollment application program 310 may manage interactions with users whereby the users consent or “opt in” to be included in the user profiles database 208 (FIG. 2).

Continuing to refer to FIG. 3, another program that may be stored in the storage device 304 is an application program 312 that controls the processor 300 to enable the user profile server computer 302 to parse or otherwise analyze the payment card account transaction data (block 212, FIG. 2) that corresponds to users who have consented to be included in the user profiles database 208. Details of the type of analysis performed by the transaction data parsing program 312 will also be discussed below in conjunction with FIG. 4.

Still further, and continuing to refer to FIG. 3, the storage device 304 may also store a user profile generation application program 314 that controls the processor 300 to enable the user profile server computer 302 to generate user profiles based on analysis performed by the transaction data parsing program 312. Again, discussion of further details of the user profile generation program 314 is deferred to the upcoming discussion of FIG. 4.

In addition, and referring again to FIG. 3, the storage device 304 may also store a request handling application program 316 that handles requests for information from, e.g., the automated seating website 202 (FIG. 2). As will be seen from subsequent discussion, the requests to the user profile server computer 302 may seek some or all of the user profile previously generated and stored by the user profile server computer 302 for a user who is currently engaged in reserving seats for an event via the automated seating website 202.

The storage device 304 may also store, and the user profile server computer 302 may also execute, other programs, which are not shown. For example, such programs may include communications software, web hosting software, and a reporting application. The latter program may respond to requests from system administrators for reports on the activities performed by the user profile server computer 302. The other programs may also include, e.g., device drivers, etc.

The storage device 304 may also store a database 318 in which payment card account transaction data is stored. The payment card account transaction database 318 stored in the storage device 304 may correspond to block 212 shown in FIG. 2. The user profile server computer 302 may have the transaction data for the database 318 downloaded to it from one or more computers (not separately shown) that constitute the payment network 110 shown in FIG. 1. Thus, the user profile server computer 302 may be in communication with and/or associated with computers operated by the operator of the payment network 110. At least some of the data in the database 318 may have been generated and/or stored by the payment network 110 in connection with processing transactions routed through the payment network 110. Data entries in the database 318 may, for example, be indexed by PANs (primary account numbers) that identify payment card accounts belonging to users, and which were charged with transactions handled by the payment network 110.

Also, the storage device 304 may store a database 320 that holds the above-mentioned user profiles. The user profile database 320 stored in the storage device 304 may correspond to block 208 in FIG. 2. The user profiles stored in the database 320 may have been generated by the user profile generation program 314 based on transaction data analysis performed by the transaction data parsing program 312.

The storage device 304 may also store one or more other databases (not shown) that are required for operation of the user profile server computer 302.

FIG. 4 is a flow chart that illustrates aspects of the present disclosure, including a portion of the operations of the user profile server computer 302 (FIG. 3).

At 402 in FIG. 4, the user profile server computer 302 sends an inquiry to an account holder (not shown), to ask the account holder whether he/she wishes to opt in for a service that will aid the account holder in booking event seating online. The inquiry to the account holder may occur as part of a batch process. To make the batch process possible, the user profile server computer 302 may have received, from the operator of the payment network 110 (FIG. 1), information concerning account holders. The information concerning account holders may include, for example, names, PANs and e-mail addresses for account holders. (The payment network, in turn, may have obtained this information from one or more of the card issuing financial institutions (issuers) that are members of or otherwise participate in the payment network.) In some embodiments, the user profile server computer 302 may also receive other contact information for the account holders, including mailing address and telephone number, and possibly demographic information as well. All of this other information may also be gathered by the operator of the payment network 110 and provided to the user profile server computer 302.

To implement step 402, the user profile server computer 302 may send e-mail messages to the account holders represented by the batch of information. The e-mail message may explain to the account holders that they have the opportunity to receive enhanced service when they book seating for events online. The e-mail from the user profile server computer 302 to the account holders may list one or more automated seating websites that will offer the enhanced seating services. In some embodiments, the e-mail message may indicate that this is a cooperative initiative between the payment network operator and the automated seating websites. The e-mail message may list potential benefits of the service for the account holder, and may indicate that seating recommendations provided by the service will be based on a computer analysis of the account holder's payment card account transactions. The e-mail may then ask the account holder whether he/she wishes to opt in to the service. For example, the e-mail message may include a virtual button or hyperlink with a label such as “Sign up”, “Enable” or “OK.”

Following block 402 in FIG. 4 is a decision block 404. At decision block 404, the user profile server computer 302 determines, for a given account holder, whether he/she has indicated a desire to opt in for the enhanced online seat reservation service. Such an indication may be given by the account holder by “clicking” on the above-described virtual button or hyperlink in the e-mail message sent to him/her by the user profile server computer 302. Thus, the determination that may be made at decision block 404 is as to whether the user profile server computer 302 has received an indication from the account holder that the account holder opts in to the enhanced online seat reservation service.

If a positive determination is made by the user profile server computer 302 at decision block 404, then block 406 may follow decision block 404. At 406, the user profile server computer 302 may access the transaction data in the payment card account transaction database 318 that corresponds to the payment card account that belongs to the user/account holder who indicated at 404 that he/she was opting in to the enhanced online seat reservation service. As noted above, the transaction data for the particular user/account holder may have been stored and/or generated in the payment network 110 (FIG. 1) over a period of time while the user was engaging in purchase transactions using his/her payment card account. Thus the transaction data may at least partially reflect purchases made over a period of time by the user, and thus may be indicative of spending habits of the user. In addition or alternatively, the overall amounts of the transactions reflected in the transaction data for the user may be indicative of an overall spending level by the user, and thus may be indicative of the status of the user in terms of the user's spending power. Still further, the record of purchases indicated by the transaction data for the user may be indicative of demographic information for the user. One example of such potential demographic information would be a potential inference that the user is the parent in a family that includes children. This inference could be expressed by categorizing the user as having a “family-oriented” demographic status, particularly if the transaction data is indicative of a considerable volume of purchases likely to have been made for children.

Following block 406 in FIG. 4 is block 408. At block 408, the user profile server computer 302 analyzes the user's transaction data that it accessed at block 406 to generate a profile for the user. There are many different possible ways in which the analysis may be performed and the user's profile may be generated. For example, the user's transaction data may be analyzed to determine whether the user should be placed in one or more of a limited number of predetermined, pre-defined categories, such as “high spending”, “family oriented”, “interested in sports”, “interested in music”, “interested in theater,” “interested in dance.” In addition or alternatively, the user may be assigned scores to indicate how well the user fits into each category in such a list of pre-defined categories.

In addition to or instead of the broad pre-defined categories described above, the user may be scored or classified with respect to subcategories, such as “interested in baseball”, “interested in football,” etc.; or “fan of [specific sports team],” or “fan of [specific type of music],” where types of music may include rap, pop, jazz, classical, opera, etc.; “fan of [particular musical artist];” or “interested in [particular theater genre],” where theater genres may include drama, musicals, experimental, etc.; or “interested in [particular genre of dance],” or “spends on small children”, “spends on teenage children”, etc.

In addition or alternatively, the analysis of the user's transaction data may include rule discovery to detect patterns in the user's spending habits. The rules to be discovered may be subject to various predetermined constraints (e.g., rules that do not fit certain pre-validated formats will be discarded) and/or the rules discovered by the data analysis may be subjected to subsequent rule validation processes. Rules that are discovered by the analysis and deemed acceptable by either prior or subsequent validation may be included in the user's profile in addition to or instead of the above-mentioned classification and/or scoring of the user.

In addition or alternatively, the user's transaction data may be analyzed in conjunction with transaction data for other users who have opted in, in order to discover clusters of user characteristics and/or habits. For example, techniques such as k-means clustering may be used for this purpose. For users that belong to one or more clusters discovered in this way, their profiles may include designations of the clusters to which they belong. In addition or alternatively, analysis of the user's transaction data may determine to what extent the user belongs to clusters discovered from earlier cluster analysis of one or more pools of user transaction data.

In some embodiments, at least a portion of the user's profile may be indicative of the user's spending habits at one or more event venues. For example, during analysis of the user's transaction data, the user profile server computer 302 may have discovered a rule that indicates that 95% of the times when the user attends a game at Yankee Stadium, the user purchases food from the Shake Shack outlet there. This particular discovered rule may be included in the profile for the user.

In some embodiments, inquiries to account holders requesting them to opt in to the seating recommendation system may be by telephone or postal mail, or by website advertising, in addition to or instead of by e-mail.

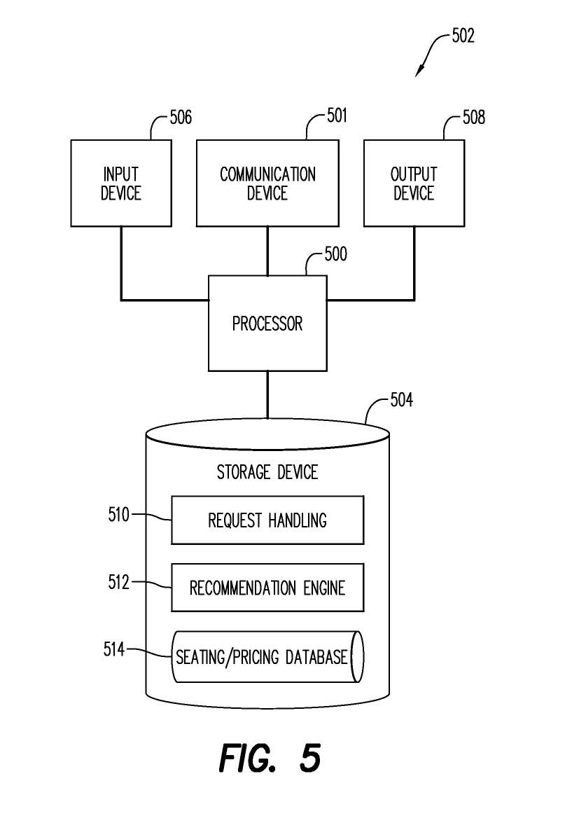

The functionality represented by block 202 (automated seating website) may be implemented by a seating website hosting computer; an example of such a computer is illustrated in block diagram form in FIG. 5 and is generally indicated by reference numeral 502 in the drawing. It will be noted that the hardware architecture of the seating website hosting computer 502 of FIG. 5 may be similar to that of the user profile server computer 302. There may indeed be overlap or commonality of structure between the two computers, as the website host organization may perform the user enrollment functions and data analysis functions described above.

Referring to FIG. 5, the seating website hosting computer 502 may be conventional in its hardware aspects, but may be controlled by software to cause it to function as described herein. For example, the seating website hosting computer 502 may be constituted by conventional server computer hardware.

The seating website hosting computer 502 may include a computer processor 500 operatively coupled to a communication device 501, a storage device 504, an input device 506 and an output device 508.

The computer processor 500 may be constituted by one or more conventional processors. Processor 500 operates to execute processor-executable steps, contained in program instructions described below, so as to control the seating website hosting computer 502 to provide desired functionality.

Communication device 501 may be used to facilitate communication with, for example, other devices (such as the user profile server computer 302; and/or one or more devices operated by individual users, such as the user device 204 shown in FIG. 2). For example, communication device 501 may comprise numerous communication ports (not separately shown), to allow the seating website hosting computer 502 to communicate simultaneously with a number of other computers and other devices. In this way, the seating website hosting computer 502 may serve a considerable number of seating requests simultaneously and/or in a short period of time.

Input device 506 may comprise one or more of any type of peripheral device typically used to input data into a computer. For example, the input device 506 may include a keyboard and a mouse. Output device 508 may comprise, for example, a display and/or a printer.

Storage device 504 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 504 stores one or more programs for controlling processor 500. The programs comprise program instructions (which may be referred to as computer readable program code means) that contain processor-executable process steps of the seating website hosting computer 502, executed by the processor 500 to cause the seating website hosting computer 502 to function as described herein.

The programs may include one or more conventional operating systems (not shown) that control the processor 500 so as to manage and coordinate activities and sharing of resources in the seating website hosting computer 502, and to serve as a host for application programs (described below) that run on the seating website hosting computer 502.

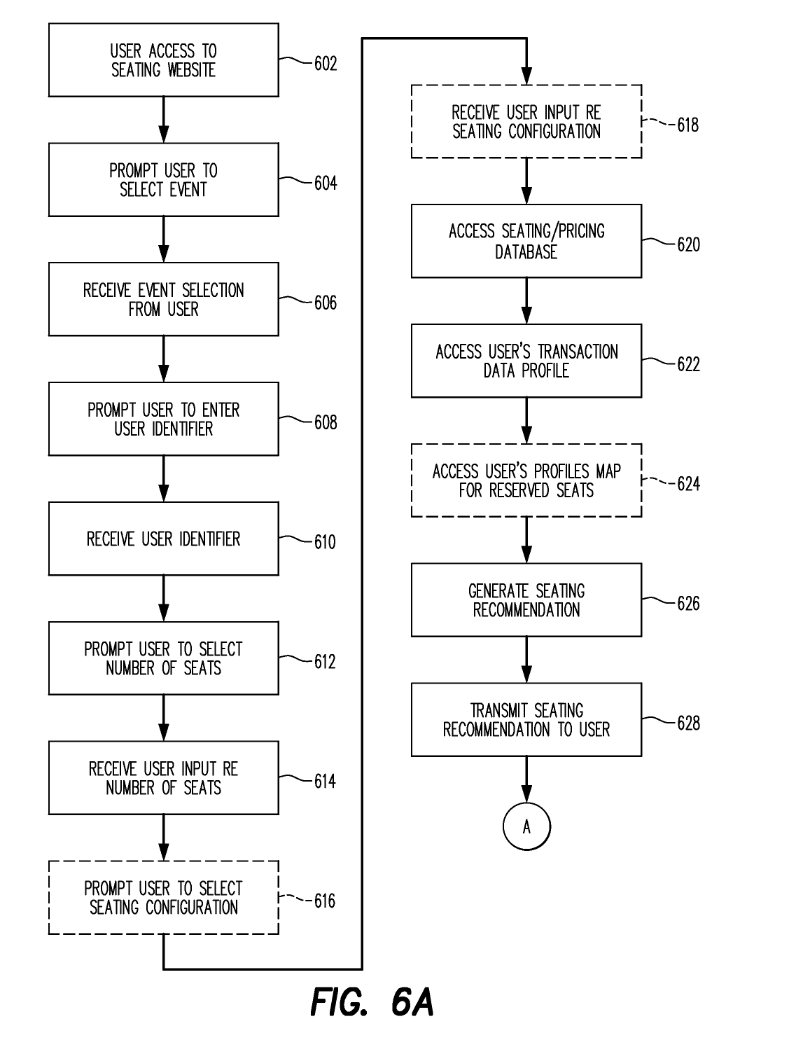

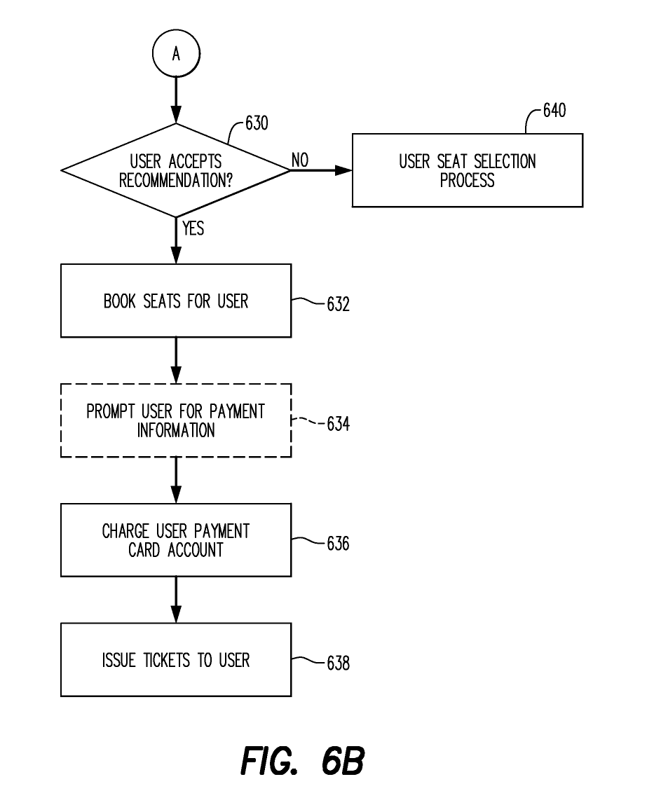

The programs stored in the storage device 504 may also include a request handling application program 510 that controls the processor 500 to enable the seating website hosting computer 502 to handle requests for seating received from user devices such as the user device 204 shown in FIG. 2. In some respects, the request handling application program 510 may provide conventional functionality, such as is commonly provided by event seating websites. In other respects, the request handling application program 510 may provide functionality in accordance with aspects of the present disclosure, as will be described below with reference to FIGS. 6A and 6B.

Continuing to refer to FIG. 5, another program that may be stored in the storage device 504 is a recommendation engine application program 512 that controls the processor 500 to enable the seating website hosting computer 502 to provide seat location recommendations to users in response to their requests for seating and in accordance with aspects of the present disclosure. The recommendation engine application program 512 may operate in conjunction with the request handling application program 510 to aid in responding to seating requests from users. Functionality provided by the recommendation engine application program will be described further below with reference to FIGS. 6A and 6B.

The storage device 504 may also store, and the seating website hosting computer 502 may also execute, other programs, which are not shown. For example, such programs may include communications software, web hosting software, and a reporting application. The latter program may respond to requests from system administrators for reports on the activities performed by the seating website hosting computer 502. The other programs may also include, e.g., device drivers, etc.

The storage device 504 may also store a seating and pricing database 514. In some embodiments, the seating and pricing database may be substantially conventional, and may store information that indicates what seats have already been booked, and what seats remain available, and what pricing applies to the available seats. In some embodiments, the seat pricing may be defined in the seating and pricing database 514 according to a tiered structure, such that the best seats are priced at a “high” pricing tier, other seats are priced at a “medium” pricing tier, and the least desirable seats are priced at a “low” pricing tier.

In some embodiments, the seating and pricing database 514 may also store, for seats that have been booked, user identifiers that identify the users who have booked the seats; the user identifiers may index user profiles for those users, so that the seating website hosting computer 502 is in effect able to map the currently booked seats in accordance with characteristics and/or interests of the users who have booked the seats.

The storage device 504 may also store one or more other databases (not shown) that are required for operation of the seating website hosting computer 502.

FIGS. 6A and 6B together form a flow chart that illustrates aspects of the present disclosure, including a portion of the operations of the seating website hosting computer 502 of FIG. 5.

At 602 in FIG. 6A, the seating website hosting computer 502 receives a signal to indicate that a user wishes to access the event seating website 202. Such a signal may come from a browser program running on the user device 204 (FIG. 2). In response, the seating website hosting computer 502 may serve a suitable webpage to the user device 204, containing suitable information to prompt the user to select a particular event for which the user wishes to obtain seating (block 604, FIG. 6A). Then, at 606, the seating website hosting computer 502 may receive input from the user device 204 to indicate the user's selection of a particular event (e.g., the name of a play and the date of the performance; or the date of a particular sporting event in which a particular sports team will be participating). At this point (block 608 in FIG. 6A), the seating website hosting computer 502 may prompt the user to identify himself/herself so that an individualized seat recommendation can be provided as per teachings of the present disclosure. For example, the user may be prompted to enter his/her PAN, which may have been used to index his/her user profile as generated at block 408 in FIG. 4. In other embodiments, in an initial step prior to block 604, the user may have been prompted to sign into his/her registered user account for the event seating website 202; in such a case, the user's PAN and/or other identifying information may already be on file and available to the seating website hosting computer 502, in which case block 608 may not be required.

Assuming that block 608 occurs, block 610 may follow. At block 610, the seating website hosting computer 502 may receive information (such as the user's PAN) that identifies the user.

Block 612 may follow block 610. At block 612, the seating website hosting computer 502 may prompt the user to indicate how many seats the user desires to reserve for the event that he/she has selected. In some embodiments, this may be done in a conventional manner. At 614, the seating website hosting computer 502 may receive input from the user indicative of the number of seats the user wants. In some embodiments, if the number of requested seats is, say, four or five seats or more, the seating website hosting computer 502 may query the user (block 616) as to whether he/she prefers a fairly compact configuration of seats divided between two or more rows or a more spread out configuration all in one row. If block 616 takes place, then block 618 may follow. At block 618, the seating website hosting computer 502 may receive, from the user, input as to what sort of seating configuration the user prefers.

At 620, the seating website hosting computer 502 accesses the seating and pricing database 514 (FIG. 5), to determine what seats are available for the selected event (i.e., the seating website hosting computer 502 may determine available seat information that is indicative of seat availability). At 622 in FIG. 6A, the seating website hosting computer 502 may access the user profile that was generated at block 408 (FIG. 4) for the current user (i.e., the user who commenced access to the event seating website at 602 and who has been participating in the subsequent steps shown in FIG. 6A). For example, the seating website hosting computer 502 may access the current user's profile via a request for the same from the seating website hosting computer 502 to the user profile server computer 302. In other embodiments, the current user's profile may have been pre-downloaded to the seating website hosting computer 502 from the user profile server computer 302. In still other embodiments, the seating website hosting computer 502 and the user profile server computer 302 may be part of the same computer system, operated by a ticketing service and/or a payment network operator that offers ticketing services as a value-added service.

In some embodiments, block 624 may also take place. At block 624, the seating website hosting computer 502 may access a map of user profiles that ties the user profiles (or portions thereof) to the seats that have already been booked for the selected event. The user profiles may have been generated from the respective users' payment card account transaction data, in a manner as described above in connection with FIG. 4.

At 626, the seating website hosting computer 502 may generate seating recommendation data for the current user, based on the information accessed at 620 and 622, and possibly also based on the information accessed at 624 (if 624 has taken place). The seating recommendation data may indicate one or more available seats, where the number of seats indicated matches the number requested by the current user at 614. The seating recommendation may be customized for the current user to reflect one or more characteristics and/or interests of the current user based on the user profile that was generated for the current user at 408 (FIG. 4). The seating recommendation may also be such as to place the current user's seating together with seats of other users who may be similar in interests and/or characteristics to the current user.

The seating website hosting computer 502 may perform block 626 in a number of ways. For example, the seating website hosting computer 502 may analyze the map of user profiles accessed at 624 in light of the current user's profile to detect one or more similarities between the current user and other users or clusters of users who have previously booked seats for the selected event. In doing so, the seating website hosting computer 502 may trade off the degree of similarity between the current user and other (previously booked) users against the degree of proximity of available seats to the other users.

In other embodiments, the seating website hosting computer 502 may use the profile for the current user to determine what pricing level among the available tickets may be most likely to meet the current user's needs or wishes. For example, the seating website hosting computer 502 may calculate a pricing level score based on one or more scores contained in the current user's profile and one or more scores that have been assigned to the selected event. The scores may have been pre-assigned to the selected event based on characteristics of the event, including the content and/or nature of the event and/or whether the event is considered to be relatively expensive or relatively inexpensive. In some embodiments, the calculation of the pricing level score may include calculating a linear combination of the current user's profile scores and the scores assigned to the event. In other embodiments, a nonlinear formula involving the current user's scores and the event's scores may be used.

In some embodiments, the calculated pricing level score may be used to determine a pricing level (e.g., a pricing level related to location in the event venue) to be recommended to the current user. The calculated pricing level score may be matched against one or more thresholds to suggest, for example, a “high,” medium” or “low” priced set of seats to the current user.

In some embodiments, the seating recommendation generated by the seating website hosting computer 502 may be based on one or more classifications of the user as contained in his/her profile, and the recommendation may be generated from one or more rules applied by the seating website hosting computer 502 to the classification(s) of the user.

Within a portion of the event venue that corresponds to the recommended price level, the seating website hosting computer 502 may also use a mapping within that portion of the event venue of other users' characteristics to seat the current user near similar users. For example, at a baseball game between the New York Yankees and the Boston Red Sox, recommended seating may place Yankee fans near other Yankee fans, and Red Sox fans near other Red Sox fans.

In some embodiments, similar users may be clustered together without directly comparing a current user's profile with those of users who previously reserved seats. For example clustering of similar users without direct comparison may occur by applying the same recommendation algorithm to similar user profiles to independently produce similar seat recommendations to similar users.

In some embodiments, if the user's profile includes venue-specific information, and if the selected event will occur at an event venue that corresponds to the venue-specific information in the user's profile, then the seating website hosting computer 502 may base the seating recommendation at least partly on the venue-specific information in the user's profile. For example, if the event is a baseball game at Yankee Stadium, and the user's profile indicates that he/she habitually buys food from the Shake Shack outlet there, then the seating recommendation from the seating website hosting computer 502 may seek to locate the user near Shake Shack.

At 628 in FIG. 6A, the seating website hosting computer 502 may transmit to the current user (i.e., to the user device 204, FIG. 2) the seating recommendation data generated at 626.

In the process of FIGS. 6A and 6B, a decision block 630 (FIG. 6B) may follow block 628 in FIG. 6A. At decision block 630, the seating website hosting computer 502 may determine whether the current user has accepted the seating recommendation sent by the seating website hosting computer 502 at 628. This may occur, for example, based on an indication received by the seating website hosting computer 502 from the user to indicate that the user wishes to reserve the recommended seats.

If a positive determination is made at decision block 630 (i.e., if the seating website hosting computer 502 determines that the user has accepted the seating recommendation), then block 632 (FIG. 6B) may follow decision block 630. At block 632, the seating website hosting computer 502 may book the recommended seats for the user.

In some embodiments, a block 634 may be performed at this point (or even prior to 632). At 634, in the event that the seating website hosting computer 502 has not heretofore received the user's PAN, the seating website hosting computer 502 may prompt the user to enter his/her payment information (e.g., his/her PAN, etc.). This may occur in a conventional manner.

At block 636, the seating website hosting computer 502 may initiate a charge to the user's payment card account for the seats booked at 632. This also may occur in a conventional manner.

At block 638, the seating website hosting computer 502 may cause tickets to be issued to the user for the seats booked at 632 and paid for at 636. This also may be accomplished in a conventional manner, including, for example, printing the tickets and mailing them to the user, having the tickets printed and held at the event venue box office “will call” window, issuing electronic tickets to be stored on the user's mobile device (which may be user device 204, FIG. 2), issuing electronic tickets to be printed by the user at home or at a kiosk at the event venue, etc.

Considering again decision block 630 in FIG. 6B, if a negative determination is made at that decision block (i.e., if the seating website hosting computer 502 determines that the user did not accept the seating recommendation), then block 640 may follow decision block 630. Block 640 may involve a conventional user-directed seat selection process, in which, for example, all available seats are displayed to the user and the user “clicks” on the representations of one or more available seats to select his/her desired seating for the selected event.

One advantage of the transaction-data-based seat recommendation process described above is that users may be placed in seats that provide them with an enhanced experience at the event in question. For example, users who may enjoy interactions with each other may be seated together based on the recommendations of the seating website hosting computer 502. Conversely, users who may prefer that no interaction occur with other audience members may also be seated together. The seats recommended by the seating website hosting computer 502 may also match the users' relative spending power and degree of interest in the particular event.

In descriptions set forth above, e.g., in connection with FIG. 4, it was indicated that the user profile server computer 302 interacted with and/or sent queries to account holders to enroll them in the seating recommendation system. In addition or alternatively, a different computer system, such as one operated by the relevant payment card account issuer 112, or a different computer operated by the payment network operator 110, may perform the querying of, and/or interaction with, prospective enrollees and may download the resulting user profiles to the user profile server computer 302.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather the method steps may be performed in any order that is practicable.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” are used interchangeably herein. The term “payment card account number” includes a number that identifies a payment card system account or a number carried by a payment card, or a number that is used to route a transaction in a payment system that handles payment card transactions. The term “payment card” includes a credit card, debit card, prepaid card, or other type of payment instrument, whether an actual physical card, electronic, or virtual.

As used herein and in the appended claims, the term “payment card system” refers to a system for handling purchase transactions and related transactions. An example of such a system is the one operated by MasterCard International Incorporated, the assignee of the present disclosure. In some embodiments, the term “payment card system” may be limited to systems in which member financial institutions issue payment card accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method comprising:
receiving from a user, in a computer, a request for seating at an event; and
fulfilling, by the computer, the request for seating, based at least in part on spending habit information for the user, the spending habit information derived from data indicative of payment card account transactions by the user.

2. The method of claim 1, wherein the spending habit information is indicative of hobbies and/or interests of the user.

3. The method of claim 2, wherein the spending habit information is indicative of the user's interest in at least one of: (a) music; (b) sports; and (c) theatrical productions.

4. The method of claim 1, wherein the spending habit information is indicative of a demographic status of the user.

5. The method of claim 1, wherein the spending habit information is indicative of a spending power status of the user.

6. The method of claim 1, wherein the spending habit information is indicative of the user's spending habits at an event venue.

7. The method of claim 6, wherein said event is scheduled to be held at said event venue.

8. The method of claim 1, wherein the event is one of the group consisting of: (a) a sporting event; (b) a musical performance; (c) a theatrical performance; and (d) a dance performance.

9. The method of claim 1, wherein the computer receives the request for seating via a website that facilitates selection of seats at an event venue.

10. The method of claim 1, wherein the fulfilling step includes recommending a seat location by the computer to the user based at least in part on the spending habit information for the user.

11. An apparatus comprising:
a processor; and
a memory in communication with the processor, the memory storing program instructions, the processor operative with the program instructions to perform the following functions:
receiving, from a user, a request for seating at an event; and
fulfilling the request for seating, based at least in part on spending habit information for the user, the spending habit information derived from data indicative of payment card account transactions by the user.

12. The apparatus of claim 11, wherein the spending habit information is indicative of hobbies and/or interests of the user.

13. The apparatus of claim 12, wherein the spending habit information is indicative of the user's interest in at least one of: (a) music; (b) sports; and (c) theatrical productions.

14. The apparatus of claim 11, wherein the spending habit information is indicative of a demographic status of the user.

15. The apparatus of claim 11, wherein the spending habit information is indicative of a spending power status of the user.

16. A method comprising:
inquiring to a payment card account holder whether the account holder opts for seating advice service based on the account holder's payment card account transaction profile;
receiving an indication from the account holder that the account holder opts for the seating advice service;
accessing payment network transaction data that corresponds to the account holder;
analyzing the accessed payment network transaction data to generate said account holder's payment card account transaction profile;
receiving an access from the account holder to a seat reservation website;
receiving, at the website, an indication from the account holder as to an event that the account holder wishes to attend;
prompting the account holder to enter information that identifies the account holder;
receiving, via the website, information from the account holder that identifies the account holder;
prompting the account holder to enter a number of seats that the account holder wishes to reserve;
receiving input from the account holder to indicate the number of seats that the account holder wishes to reserve;
accessing a database to determine available seat information, the available seat information indicative of seats that are available for the event;
accessing the generated payment card account transaction profile for the account holder;
generating seating recommendation data based on (a) the accessed payment card account transaction profile for the account holder; and (b) the determined available seat information; the seating recommendation data indicative of a plurality of available seats for the event;
transmitting the generated seating recommendation data to the account holder;
receiving an indication from the account holder that the account holder desires to reserve the plurality of available seats indicated by the seating recommendation data;
initiating a charge to a payment card account that belongs to the account holder; and
issuing tickets to the account holder for the plurality of available seats indicated by the seating recommendation data.

17. The method of claim 16, wherein said received information from the account holder that identifies the account holder is a primary account number (PAN) that identifies said payment card account that belongs to the account holder.

18. The method of claim 16, wherein said received information from the account holder that identifies the account holder is a website user identifier for said website;
and the method further comprising:
receiving payment card account information from the account holder.

19. The method of claim 16, wherein said account holder's payment card account transaction profile is indicative of spending habits of the account holder.

20. The method of claim 16, wherein said step of generating seating recommendation data is also based on (c) payment card account transaction profiles of individuals who have reserved seats for the event prior to the step of receiving the access from the account holder to the seat reservation website.
